(19) United States
(12) Patent Application Publication
(10) Pub. No.: US 2014/0013068 A1
(43) Pub. Date: Jan. 9, 2014

(54) INFORMATION PROCESSING APPARATUS, STORAGE SYSTEM, AND WRITE CONTROL METHOD

(71) Applicant: FUJITSU LIMITED, Kawasaki-shi (JP)

(72) Inventors: Takaaki YAMATO, Nagano (JP); Fumio Matsuo, Nagano (JP); Nobuyuki Hirashima, Nagano (JP); Takashi Murayama, Nagano (JP); Noritake Komatsu, Nagano (JP)

(73) Assignee: FUJITSU LIMITED, Kawasaki-shi (JP)

(21) Appl. No.: 14/021,467

(22) Filed: Sep. 9, 2013

Related U.S. Application Data
(63) Continuation of application No. PCT/JP2011/056381, filed on Mar. 17, 2011.

(51) Int. Cl. G06F 12/00

(52) U.S. Cl. CPC G06F 12/00
USPC 711/154

(57) ABSTRACT

An information processing apparatus includes a write control unit that executes in parallel a first process in which a writing unit writes, to a storage device, data that are requested to be written to the storage device, and a second process in which a compression unit compresses the data and the writing unit writes compressed data obtained by the compression to the storage device. The write control unit specifies the data written by one of the first and second processes that takes less processing time as valid write data in the storage device.

### CROSS-REFERENCE TO RELATED APPLICATION

This application is a continuation application of International Application PCT/JP2011/056381 filed on Mar. 17, 2011 which designated the U.S., the entire contents of which are incorporated herein by reference.

### FIELD

The embodiments discussed herein are related to an information processing apparatus, a storage system, and a write control method.

### BACKGROUND

In recent years, hierarchical virtual storage systems have become known in which inexpensive large-capacity recording media, such as magnetic tapes, are used as a back-end library apparatus, and in which recording media that allow high speed access, such as hard disk drives (HDDs), are used as a cache apparatus. In such a virtual storage system, data stored in a cache apparatus are virtually recognized by a host apparatus as data stored in a library apparatus. Thus, the host apparatus is able to use a large storage area provided by the library apparatus as if the storage area were connected to the host apparatus.

In order to reduce the amount of data stored in a back-end library apparatus, some virtual storage systems have a function of compressing data for which a write request is issued by a host apparatus. For example, one of such virtual storage systems compresses data for which a write request is issued by a host apparatus, writes the compressed data to a cache apparatus, reads the compressed write data from the cache apparatus, and stores the compressed write data in a back-end library apparatus.

As an example of the technique for compressing and storing data in a storage device, there is a technique that compresses part of input data using different compression methods in parallel, selects the compression method that completed compression with the shortest time, and compresses the remaining input data using the selected compression method. There is also a technique that compresses data to be backed up in units of blocks of a constant length, using different compression methods, selects data having the smallest size among uncompressed data and compressed data for each of the blocks, and stores the selected data as backup data. Further, there is a method for storing files in a storage device having a compression function. With this method, a file having a compression rate higher than a threshold and a file having a compression rate lower than the threshold are alternately stored using a temporary storage area.

Note that these techniques are disclosed, for example, in the following literature:
Japanese Laid-open Patent Publication No. 7-210324;
Japanese Laid-open Patent Publication No. 2005-293224; and
Japanese Laid-open Patent Publication No. 2008-293147.

By the way, processing time for compressing and storing data in a storage device includes time to compress data and time to transfer the compressed data to the storage device. Generally, the residual rate of data after compression varies from data to data. Accordingly, in the case where the residual rate of data after compression is high, the time taken to compress data and store the compressed data in a storage device might be longer than the time taken to store the data in a storage device without compressing the data. In such a case, even if the storage space needed to store the data is reduced, the total processing time taken to store the data is increased.

### SUMMARY

According to one aspect of the invention, there is provided an information processing apparatus that includes a processor configured to perform a procedure including: executing a first process of writing, to a storage apparatus, first data that are requested to be written to the storage apparatus, and a second process of compressing the first data and writing second data that are obtained by the compression to the storage apparatus; and terminating one of the first and second processes that takes longer processing time.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates en exemplary configuration of an information processing apparatus according to a first embodiment;

FIG. 2 illustrates an exemplary configuration of a storage system according to a second embodiment;

FIG. 3 illustrates an exemplary hardware configuration of a channel processor;

FIG. 4 is a first time chart illustrating examples of writing data to a disk array apparatus by a channel processor;

FIG. 5 is a second time chart illustrating examples of writing data to a disk array apparatus by a channel processor;

FIG. 6 is a time chart illustrating an example of writing data according to the second embodiment;

FIG. 7 is a functional block diagram illustrating a virtual library control processor and a channel processor;

FIG. 8 illustrates an example of information stored in a data management table;

FIG. 9 illustrates an exemplary configuration of data written in a disk array apparatus;

FIG. 10 is a flowchart illustrating an exemplary procedure of writing data to the disk array apparatus by the channel processor;

FIG. 11 is a flowchart illustrating an exemplary procedure of writing data to the disk array apparatus by the channel processor according to a third embodiment;

FIG. 12 is a functional block diagram illustrating a channel processor and a virtual library control processor according to a fourth embodiment; and

FIG. 13 is a flowchart illustrating an exemplary procedure of writing data to the disk array apparatus by the channel processor according to the fourth embodiment.

### DESCRIPTION OF EMBODIMENTS

Several embodiments will be described below with reference to the accompanying drawings, wherein like reference numerals refer to like elements throughout.

### (a) First Embodiment

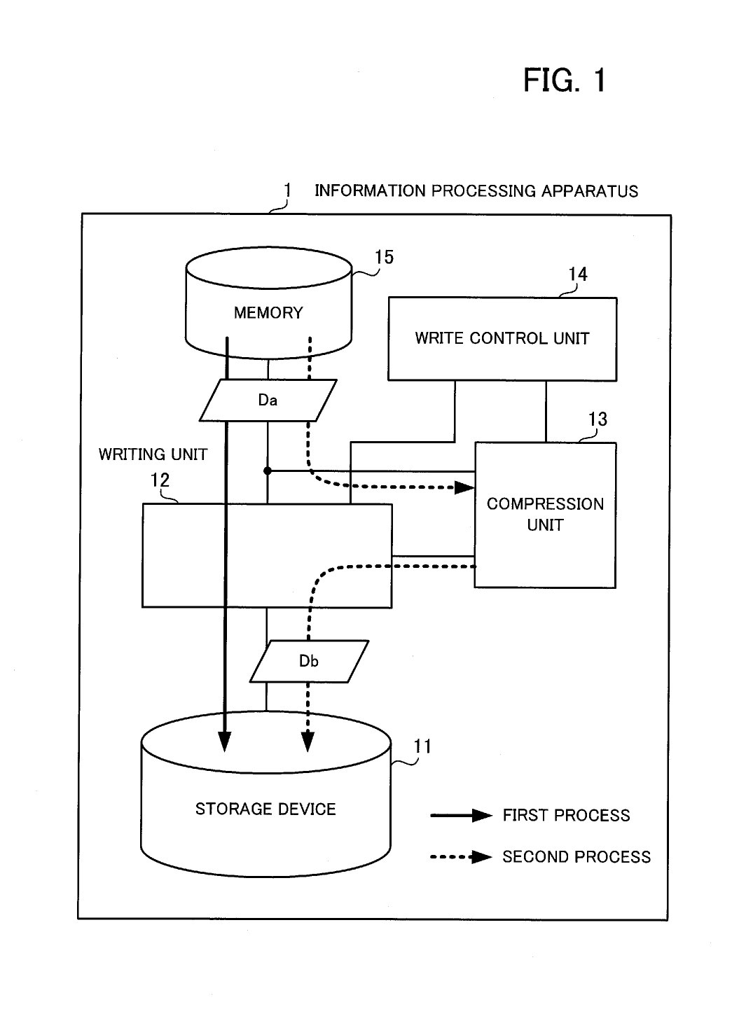

FIG. 1 illustrates en exemplary configuration of an information processing apparatus 1 according to a first embodiment.

The information processing apparatus 1 of FIG. 1 includes a writing unit 12 that writes data to a storage device 11, a compression unit 13 that compresses data, and a write control unit 14 that controls writing of data to the storage device 11 using the writing unit 12 and the compression unit 13. In the example illustrated in FIG. 1, the storage device 11 is provided inside the information processing apparatus 1. However, the storage device 11 may be provided separately from the information processing apparatus 1.

Hereinafter, a description will be given of operations performed in the information processing apparatus 1 in response to a request for writing data Da stored in a memory 15 of the information processing apparatus 1 to the storage device 11. Note that the data Da requested to be written may be data received from an apparatus that is provided separately from the information processing apparatus 1.

When writing the data Da stored in the memory 15 to the storage device 11, the write control unit 14 starts the following first and second processes at the same time so as to execute these processes in parallel. The first process is a process in which the writing unit 12 writes the data Da to the storage device 11 without making any changes thereto. The second process is a process in which the compression unit 13 compresses the data Da, and the writing unit 12 writes compressed data Db obtained by the compression to the storage device 11. The write control unit 14 specifies the data written in the storage device 11 by one of the first and second processes that takes less processing time as valid write data in the storage device 11.

For example, in the case where the processing time of the second process is less than that of the first process, the write control unit 14 specifies the compressed data Db written in the storage device 11 by the second process as valid write data. In this case, compared with the case of writing the data Da to the storage device 11 in an uncompressed form, it is possible to reduce the amount of data written in the storage device 11, to save the storage space of the storage device 11, and to reduce the processing time taken for the entire writing process.

On the other hand, in the case where the compression efficiency of the data Da by the compression unit 13 is not very high so that the size of the compressed data Db is relatively large and therefore it takes long time to write the compressed data Db, the processing time of the second process is longer than that of the first process. In this case, the write control unit 14 specifies the uncompressed data Da written by the first process as valid write data. Accordingly, although the usage of the storage space of the storage device 11 is not reduced, it is possible to reduce the processing time taken for the entire writing process.

Note that in the case where the first process and the second process take the same time, the write control unit 14 may specify the compressed data Db written in the storage device 11 by the second process as valid write data. Thus, it is possible to save the storage space of the storage device 11.

With the above-described control process by the write control unit 14, it is possible to reduce the amount of data stored in the storage device 11, and also to reduce the time taken to store the data.

Note that the write control unit 14 may perform the following operations. The write control unit 14 executes the first and second processes in parallel, and monitors which of the first and second processes is completed first. Then, upon detection of completion of one of the first and second processes, the write control unit 14 may specify data written in the storage device 11 by the completed process as valid write data.

Further, the data compression efficiency by the compression unit 13 may be determined after the data compression is actually completed by the compression unit 13. Accordingly, the write control unit 14 may perform the following operations. In the second process, when the compression of the data Da by the compression unit 13 is completed, the write control unit 14 compares the amount of the compressed data Db with the amount of the unwritten data that are yet to be written in the storage device 11 by the writing unit 12 in the first process.

If the amount of the compressed data Db is less than or equal to the amount of the unwritten data, the write control unit 14 continues the second process and terminates the first process of wiring the original data Da to the storage device 11. Thus, the writing unit 12 writes the compressed data Db to the storage device 11, so that the compressed data Db become valid write data.

On the other hand, if the amount of the compressed data Db is greater than the amount of the unwritten data, the write control unit 14 continues the first process and terminates the second process. Thus, the compressed data Db are not written in the storage device 11, so that the original data Da become valid write data.

Next, a description will be given of an embodiment in which a storage system is provided with the processing functions of the above-described information processing apparatus 1.

### (b) Second Embodiment

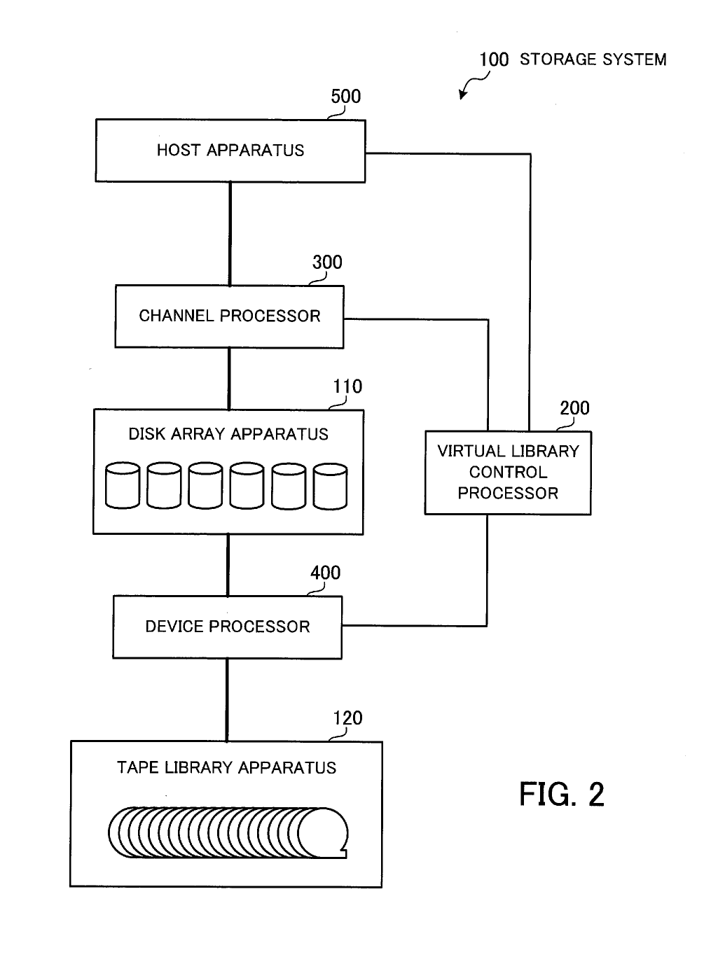

FIG. 2 illustrates an exemplary configuration of a storage system 100 according to a second embodiment.

The storage system 100 of FIG. 2 includes a disk array apparatus 110, a tape library apparatus 120, a virtual library control processor 200, a channel processor 300, and a device processor 400. A host apparatus 500 is connected to the virtual library control processor 200 and the channel processor 300.

Transmission path conforming to, for example, the Fibre Channel (FC) standards is provided for connection between the host apparatus 500 and the channel processor 300, between the channel processor 300 and the disk array apparatus 110, between the disk array apparatus 110 and the device processor 400, and between the device processor 400 and the tape library apparatus 120. Further, the virtual library control processor 200 is connected to the host apparatus 500, the channel processor 300, and the device processor 400, over a local area network (LAN), for example.

The disk array apparatus 110 is a storage apparatus including a plurality of hard disk drives (HDDs). The tape library apparatus 120 is a storage apparatus including magnetic tapes as recording media. The tape library apparatus 120 includes one or more tape drives that access data on the magnetic tapes, a mechanism that transports tape cartridges accommodating the magnetic tapes, and the like.

The virtual library control processor 200 controls the storage system 100 to operate as a hierarchical virtual library system in which the disk array apparatus 110 serves as a primary storage (tape volume cache) and the tape library apparatus 120 as a secondary storage. In the virtual library system, the host apparatus 500 may virtually use a large-capacity storage area realized by the tape library apparatus 120 via the disk array apparatus 110.

Examples of recording media that may be used in the secondary storage of the virtual library system include portable recording media such as optical discs, magneto-optical disks, and the like, other than magnetic tapes. Further, examples of storage devices that may be used in the primary storage of the virtual library system include solid state drives (SDD) and the like, other than HDDs.

The channel processor 300 accesses the disk array apparatus 110 in response to an access request to the virtual library system from the host apparatus 500, under the control of the virtual library control processor 200. For example, when a data write request is issued by the host apparatus 500, the channel processor 300 receives write data from the host apparatus 500, writes the write data to the disk array apparatus 110, and notifies the virtual library control processor 200 of a write address of the write data in the disk array apparatus 110. On the other hand, when a data read request is issued by the host apparatus 500, the channel processor 300 receives a notification of a read address from the virtual library control processor 200, reads data from the notified read address in the disk array apparatus 110, and transmits the read data to the host apparatus 500. Further, the channel processor 300 has a function of compressing data for which a write request is issued by the host apparatus 500, and writing the compressed data to the disk array apparatus 110.

The device processor 400 accesses the disk array apparatus 110 and the tape library apparatus 120, and transfers data between the disk array apparatus 110 and the tape library apparatus 120, under the control of the virtual library control processor 200.

The host apparatus 500 issues an access request to the virtual library control processor 200 in response to an input operation by the user, and thereby accesses the virtual library system. For example, upon writing data to the virtual library system, the host apparatus 500 issues a write request to the virtual library control processor 200, and transmits write data to the channel processor 300. On the other hand, upon reading data stored in the virtual library system, the host apparatus 500 issues a read request to the virtual library control processor 200, and receives read data from the channel processor 300.

In the host apparatus 500, the CPU of the host apparatus 500 executes a predetermined program such as backup software or the like, for example, so that access is made to the virtual library system. Further, upon transmitting write data to the channel processor 300, the host apparatus 500 divides the write data into data blocks of a constant length, and transmits the data blocks. Further, the host apparatus 500 combines data blocks received from the channel processor 300 so as to restore read data.

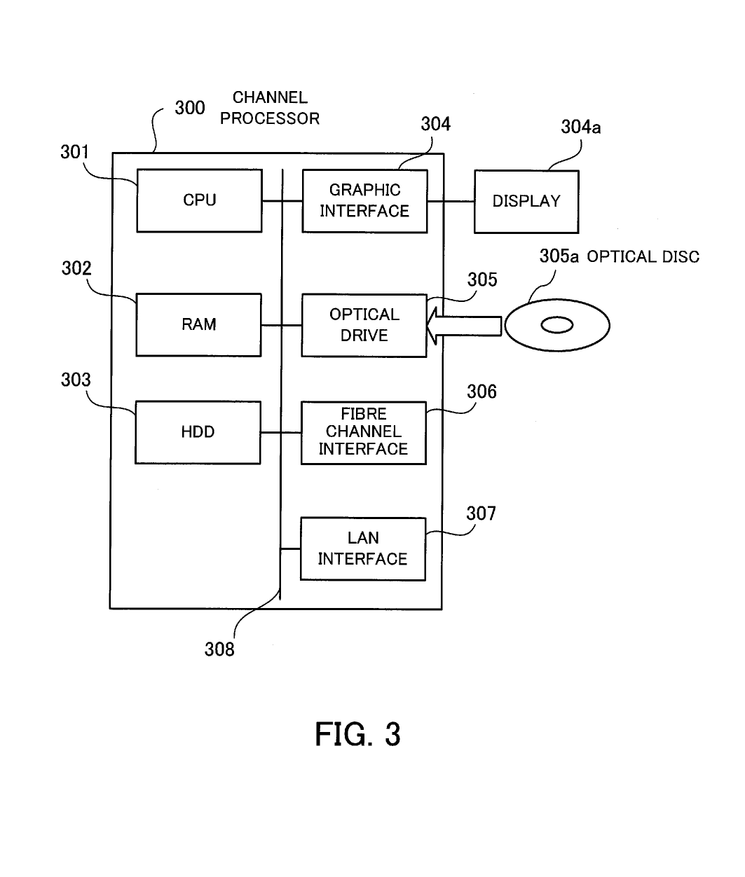

FIG. 3 illustrates an exemplary hardware configuration of the channel processor 300.

The channel processor 300 may be implemented as a computer illustrated in FIG. 3, for example. The entire operation of the channel processor 300 is controlled by a CPU 301. A random access memory (RAM) 302 and a plurality of peripheral devices are connected to the CPU 301 via a bus 308.

The RAM 302 serves as a primary storage device of the channel processor 300. The RAM 302 temporarily stores at least part of the operating system (OS) program and application programs that are executed by the CPU 301. The RAM 302 also stores various types of data that are used in processing performed by the CPU 301.

The peripheral devices connected to the bus 308 include an HDD 303, a graphic interface 304, an optical drive 305, a Fibre Channel interface 306, and a LAN interface 307.

The HDD 303 magnetically writes data to and reads data from an internal magnetic disk. The HDD 303 serves as a secondary storage device of the channel processor 300. The HDD 303 stores the OS program, application programs, and various types of data. Note that a semiconductor storage device such as a flash memory and the like may alternatively be used as the secondary storage device.

A display 304a is connected to the graphic interface 304. The graphic interface 304 displays various types of images on the screen of the display 304a in accordance with an instruction from the CPU 301.

The optical drive 305 reads data from an optical disc 305a, using laser beams or the like. The optical disc 305a is a portable storage medium storing data such that the data may be read by reflection of light. Examples of the optical disc 305a include digital versatile disc (DVD), DVD-RAM, compact disc read only memory (CD-ROM), CD-Recordable (CD-R), and CD-Rewritable (CD-RW).

The Fibre Channel interface 306 transmits data to and receives data from the host apparatus 500 and the disk array apparatus 110 via the transmission path conforming to the Fibre Channel standards. The LAN interface 307 transmits data to and receives data from the virtual library control processor 200 over the LAN.

Note that each of the virtual library control processor 200, the device processor 400, and the host apparatus 500 may be implemented as a computer similar to that illustrated in FIG. 3.

Next, a description will be given of how the channel processor 300 writes data to the disk array apparatus 110.

As mentioned above, the channel processor 300 has a function of compressing write data received from the host apparatus 500. The host apparatus 500 divides write data into data blocks of a constant length, and transmits the data blocks to the channel processor 300. The channel processor 300 performs compression for each received data block, and writes compressed data block to the disk array apparatus 110.

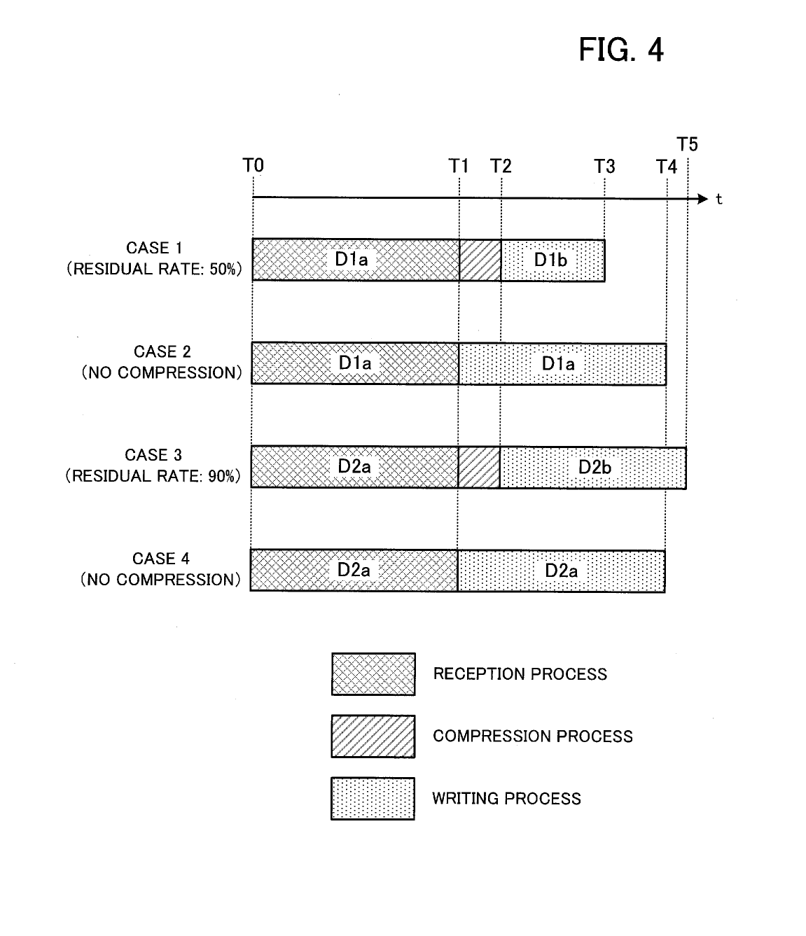

FIG. 4 is a first time chart illustrating examples of writing data to the disk array apparatus 110 by the channel processor 300.

In FIG. 4, the “reception process” is a process in which the channel processor 300 receives data blocks transmitted from the host apparatus 500, and the received data blocks are stored in the RAM 302 of the channel processor 300. The “compression process” is a process in which the CPU 301 reads the data blocks stored in the RAM 302 and compresses the read data blocks, and compressed data obtained by the compression are stored in the RAM 302. The “writing process” is a process in which the data blocks or the compressed data stored in the RAM 302 are transmitted to and stored in the disk array apparatus 110.

For simplicity of explanation, it is assumed that the data transfer rate from the host apparatus 500 to the channel processor 300 in the “reception process” is equal to the data transfer rate from the channel processor 300 to the disk array apparatus 110 in the “writing process”. The data transfer rate in these processes may be around several gigabits per second, for example. On the other hand, in the “compression process”, data are transferred between the CPU 301 and the RAM 302 via the bus 308 in the channel processor 300. The data transfer rate in this process may be around several gigabytes per second, for example. Accordingly, the processing speed of the “compression process” is obviously higher than the processing speed of the “reception process” and the “writing process”. Note that the time taken to compress a data block is the same for data blocks subjected to compression.

Cases 1 and 2 of FIG. 4 illustrate the cases where the channel processor 300 receives a data block D1a from the host apparatus 500 and writes the data block D1a to the disk array apparatus 110. In Case 1, the data block D1a is compressed to generate compressed data D1b, and then the compressed data D1b are written to the disk array apparatus 110. In Case 2, the data block D1a is written to the disk array apparatus 110 in an uncompressed form.

Cases 3 and 4 of FIG. 4 illustrate the cases where the channel processor 300 receives a data block D2a from the host apparatus 500 and writes the data block D2a to the disk array apparatus 110. In Case 3, the data block D2a is compressed to generate compressed data D2b, and then the compressed data D2b are written to the disk array apparatus 110. In Case 4, the data block D2a is written to the disk array apparatus 110 in an uncompressed form.

Since the data blocks have a constant length, the time taken to receive the data block D1a in Cases 1 and 2 and the time taken to receive the data block D2a in Cases 3 and 4 are both (T1-T0). Further, the time taken to compress the data block D1a in Case 1 and the time taken to compress the data block D2a in Case 3 are both (T2-T1).

The residual rate of data after compression varies from data to data. In the example illustrated in FIG. 4, the residual rate of the data block D1a after compression is 50%, and the residual rate of the data block D2a after compression is 90%. In this case, the time (T5-T2) taken to write the compressed data D2b generated by compressing the data block D2a to the disk array apparatus 110 is longer than the time (T3-T2) taken to write the compressed data D1b generated by compressing the data block D1a to the disk array apparatus 110.

In the case of writing to the disk array apparatus 110 the data block D1a that has a low residual rate after compression, the processing time (T3-T1) of Case 1 taken to perform compression and write the compressed data D1b to the disk array apparatus 110 is less than the processing time (T4-T0) of Case 2 taken to write the original data block D1a to the disk array apparatus 110 without performing compression. That is, in Case 1, since compression is performed, it is possible to save the space of the disk array apparatus 110, and to reduce the time taken for the entire data writing process.

On the other hand, in the case where the residual rate after compression is high, the time taken to compress data and store the compressed data to the disk array apparatus 110 might be longer than the time taken to write data to the disk array apparatus 110 without performing compression. In the example illustrated in FIG. 4, in the case of writing the data block D2a to the disk array apparatus 110, the processing time (T5-T0) of Case 3 taken to perform compression and write the compressed data D2b to the disk array apparatus 110 is longer than the processing time (T4-T0) of Case 4 taken to write the original data block D2a to the disk array apparatus 110 without performing compression. In this case, although it is possible to save the space of the disk array apparatus 110 by performing compression, the time taken for the entire data writing process is increased.

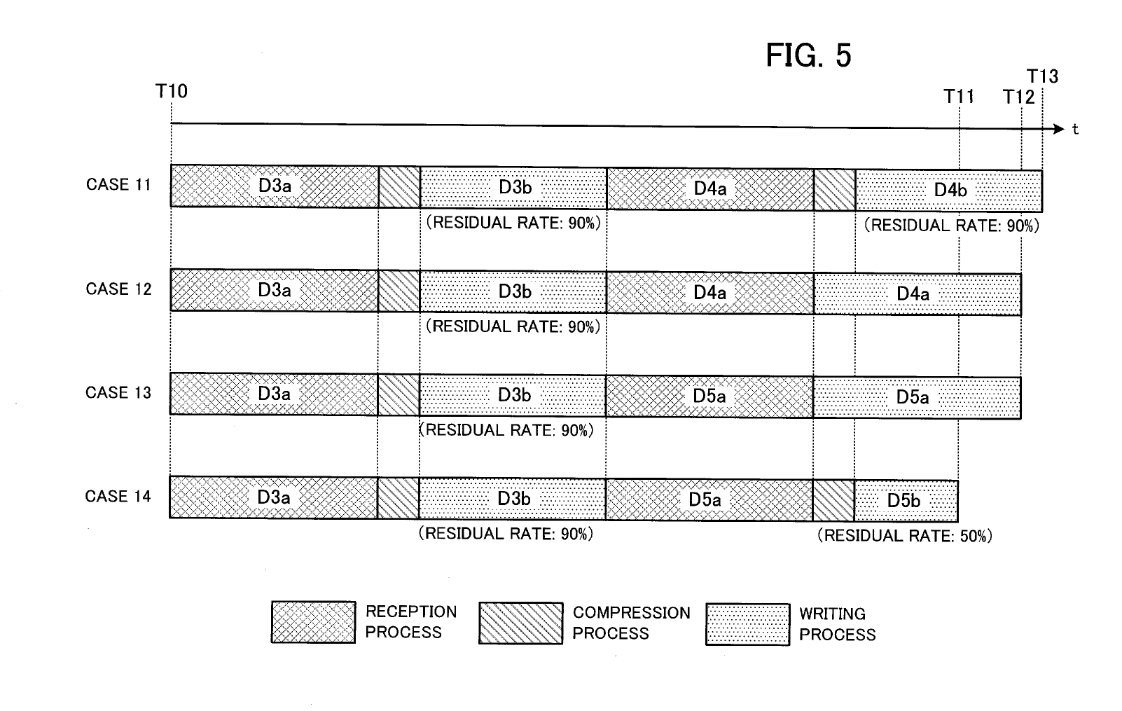

FIG. 5 is a second time chart illustrating examples of writing data to the disk array apparatus 110 by the channel processor 300.

In FIG. 5, both the data blocks D3a and D4a have a 90% residual rate after compression. Case 11 illustrates the case where the data block D3a is received and compressed; the obtained compressed data D3b are written to the disk array apparatus 110; the subsequent data block D4a is received and compressed; and the obtained compressed data D4b are written to the disk array apparatus 110. The processing time (T13-T10) of Case 11 is longer than the processing time taken to write both the data blocks D3a and D4a to the disk array apparatus 110 in an uncompressed form.

One method to address this problem would be to determine, in accordance with the residual rate upon compression of a data block, whether to compress a predetermined number of subsequent data blocks. This method takes advantage of the fact that successively received data blocks are highly likely to have close residual rates after compression. Case 12 illustrates the case where this method is used. In Case 12, the channel processor 300 detects, after compression of the data block D3a, the residual rate of the obtained compressed data D3b. The channel processor 300 determines that the detected residual rate is higher than a predetermined threshold, and writes the subsequently received data block D4a to the disk array apparatus 110 in an uncompressed form. With this process, the processing time (T12-T10) of Case 12 is less than the processing time (T13-T10) of Case 11.

However, a data block having a high residual rate after compression is not always followed by another data block having a high residual rate after compression. For example, Cases 13 and 14 illustrates the case where the data block D3a having a residual rate of 90% is received and then a data block D5a having a residual rate of 50% is received.

In Case 13, similar to Case 12, after the compressed data D3b are written to the disk array apparatus 110, because the residual rate of the compressed data D3b is greater than a predetermined threshold, the data block D5a is written to the disk array apparatus 110 in an uncompressed form. On the other hand, in Case 14, both the data blocks D3a and D5a are written to the disk array apparatus 110 in a compressed form. The processing time (T12-T10) of Case 13 is longer than the processing time (T11-T10) of Case 14. Even if a determination of whether to compress a data block on the basis of the detection result of a residual rate of previous data as in the examples of Case 12 and 13, the processing time is not always minimized.

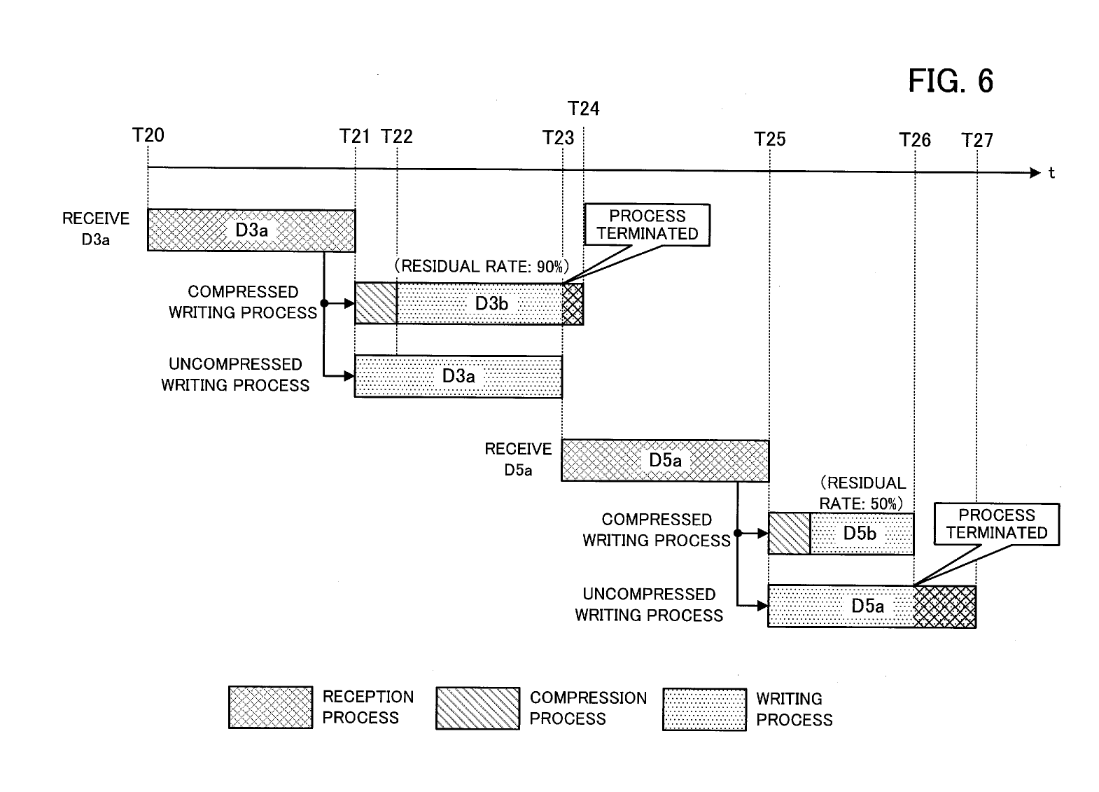

In the present embodiment, the method illustrated in FIG. 6 is used in order to minimize the time taken to write data, regardless of the residual rate after compression of each data block. FIG. 6 is a time chart illustrating an example of writing data according to the second embodiment.

The channel processor 300 starts reception of the data block D3a at time T20. The channel processor 300 completes the reception of the data block D3a (the writing to the RAM 302) at time T21, and starts a “compressed writing process” and an “uncompressed writing process” at the same time so as to execute these processes in parallel.

The “compressed writing process” is a process of compressing the received data block D3a, and writing the compressed data D3b obtained by the compression to the disk array apparatus 110. In the compressed writing process of the data block D3a, the compression process (i.e., the process of generating the compressed data D3b and writing the compressed data D3b to the RAM 302) is completed at time T22, and then a process of wiring the compressed data D3b to the disk array apparatus 110 starts. On the other hand, the “uncompressed writing process” is a process of writing the received data block D3a to the disk array apparatus 110 in an uncompressed form.

The channel processor 300 monitors which of the compressed writing process and the uncompressed wiring process that are executed in parallel is completed first. As mentioned above with reference to FIG. 5, since the data block D3a has a 90% residual rate after compression, and thus has a relatively low compression efficiency, the uncompressed writing process of the data block D3a is completed first.

When the channel processor 300 detects that the uncompressed writing process of the data block D3a is completed at time T23, the channel processor 300 terminates the compressed writing process of the data block D3a. At time T23, although the writing of the compressed data D3b is in progress, the writing of the compressed data D3b is terminated. The channel processor 300 performs, for example, an operation such as registering write position information of the data block D3a in the disk array apparatus 110 into the virtual library control processor 200, and thereby validates the data block D3a written in the disk array apparatus 110. Also, the channel processor 300 invalidates the compressed data D3b that have been written in the disk array apparatus 110 by time T23.

In the above-described period from time T20 to time T23, the writing of the data block D3a is completed. Assuming that the compressed writing process of the data block D3a is continued, the compressed writing process is completed at time T24. That is, compared to the case of compressing the data block D3a and writing the compressed data D3b to the disk array apparatus 110, it is possible to reduce the time taken to complete the writing process by a time period (T24-T23).

Then, the channel processor 300 starts reception of the data block D5a at time T23. The channel processor 300 completes the reception of the data block D5a (the writing to the RAM 302) at time T25, and executes a compressed writing process and an uncompressed writing process of the data block D5a in parallel. In the meantime, the channel processor 300 monitors which of the compressed writing process and the uncompressed wiring process that are executed in parallel is completed first.

As mentioned above with reference to FIG. 5, since the data block D5a has a 50% residual rate after compression and thus has a relatively high compression efficiency, the compressed writing process of the data block D5a is completed first. When the channel processor 300 detects that the compressed writing process of the data block D5a is completed at time T26, the channel processor 300 terminates the uncompressed writing process of the data block D5a. At time T26, although the writing of the original data block D5a is in progress, the writing of the data block D5a is terminated.

The channel processor 300 performs, for example, an operation such as registering write position information of the compressed data D5b in the disk array apparatus 110 into the virtual library control processor 200, and thereby validates the compressed data D5b written in the disk array apparatus 110. Also, the channel processor 300 invalidates the data block D5a that has been written in the disk array apparatus 110 by time T26.

In the above-described period from time T23 to time T26, the writing of the data block D5a is completed. Assuming that the uncompressed writing process of the data block D5a is continued, the uncompressed writing process is completed at time T27. That is, compared to the case (Case 13 of FIG. 5) of writing the data block D5a in an uncompressed form, it is possible to reduce the time taken to complete the writing process by a time period (T27-T26).

As in the above-described processing example of FIG. 6, the channel processor 300 executes, in parallel, a compressed writing process and an uncompressed writing process for each data block requested to be written to the disk array apparatus 110. Then, the channel processor 300 specifies, as valid write data, the data written in the disk array apparatus 110 by one of the parallel processes that is completed first. Thus, it is possible to reliably reduce the overall processing time taken to write data to the disk array apparatus 110, to save the storage space in the disk array apparatus 110 and the tape library apparatus 120 as much as possible, and to increase the data writing efficiency.

Note that in the example of FIG. 6, after a process of writing a data block to the disk array apparatus 110 is completed, a subsequent data block is received from the host apparatus 500. However, the writing to the disk array apparatus 110 and the reception from the host apparatus 500 may be performed asynchronously. In this case, the channel processor 300 sequentially receives data blocks from the host apparatus 500, and stores the received data blocks in the RAM 302. In the meantime, the channel processor 300 sequentially reads the data blocks stored in the RAM 302 asynchronously with storing of the data blocks in the RAM 302, and executes a compressed writing process and an uncompressed writing process in parallel as illustrated in FIG. 6. Even in this case, it is possible to reduce the time taken to write data to the disk array apparatus 110.

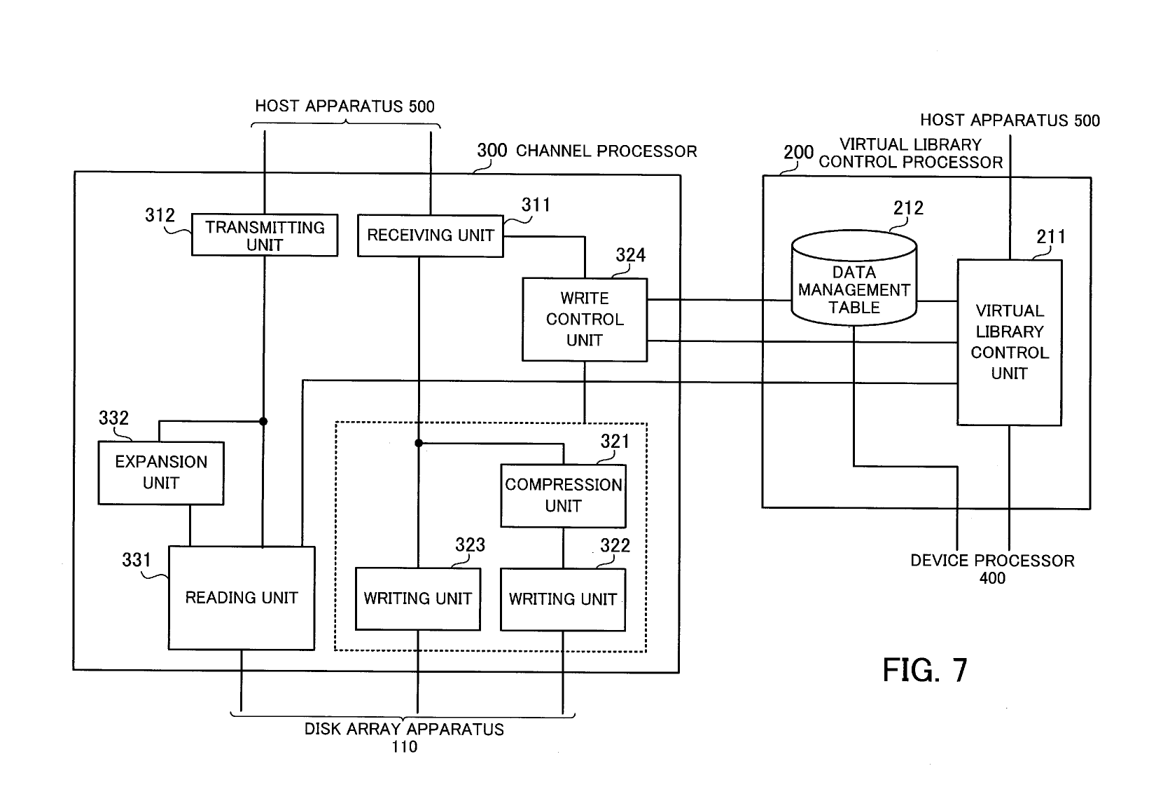

FIG. 7 is a functional block diagram illustrating the virtual library control processor 200 and the channel processor 300.

The virtual library control processor 200 includes a virtual library control unit 211. The CPU of the virtual library control processor 200 executes a predetermined program, for example, so as to realize operations of the virtual library control unit 211. Further, a data management table 212 is stored in a storage device of the virtual library control processor 200.

On the other hand, the channel processor 300 includes a receiving unit 311, a transmitting unit 312, a compression unit 321, writing units 322 and 323, a write control unit 324, a reading unit 331, and an expansion unit 332. The CPU 301 of the channel processor 300 executes a predetermined program, for example, so as to realize operations of these processing blocks.

In response to an access request to the virtual library system from the host apparatus 500, the virtual library control unit 211 of the virtual library control processor 200 controls data access to the disk array apparatus 110, data access to the magnetic tapes in the tape library apparatus 120, and the like. Further, the virtual library control unit 211 controls reception and transmission of data between the host apparatus 500 and the disk array apparatus 110 by referring to the data management table 212 that manages locations of data blocks stored in the disk array apparatus 110.

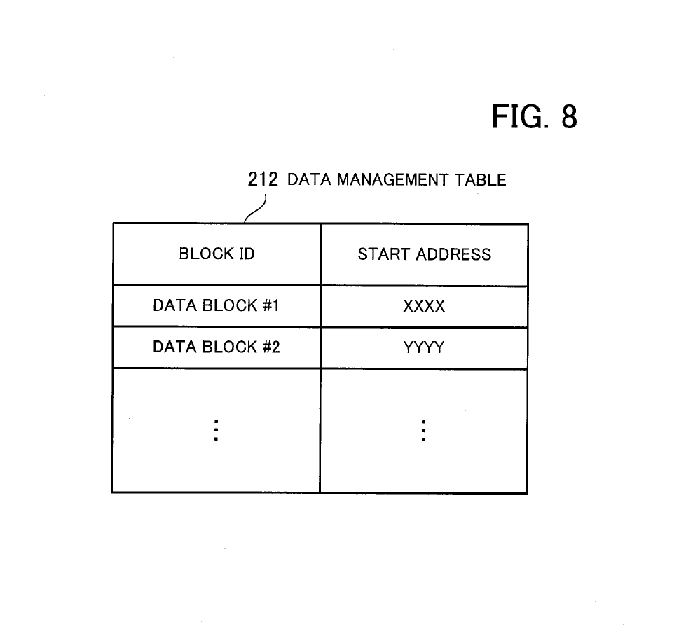

FIG. 8 illustrates an example of information stored in the data management table 212.

In the data management table 212, a record is generated for each data block. In each record, a block ID for identifying the data block and storage location information of the data block in the disk array apparatus 110 are registered. In the example illustrated in FIG. 8, a start address of a region where a data block is stored in the disk array apparatus 110 is registered as storage location information of the data block.

Note that, in the data management table 212, the amount of write data and the like may be recorded together with the start address, for example. Further, the storage location information of the data block stored in the data management table 212 is not limited to the start address. Examples of storage location information include an address indicating the storage location of a subsequent data block and the like.

Referring back to FIG. 7, the write control unit 324 of the channel processor 300 registers data in the data management table 212. Upon reception of a data write request from the host apparatus 500, the virtual library control unit 211 requests the write control unit 324 of the channel processor 300 to write to the disk array apparatus 110 the write data transmitted from the host apparatus 500. The write data are divided into data blocks of a constant length and transmitted to the channel processor 300 by the host apparatus 500. Each time process of writing a data block received from the host apparatus 500 to the disk array apparatus 110 is completed, the write control unit 324 registers the block ID and the start address of the written data block into the data management table 212.

The virtual library control unit 211 requests the device processor 400 to copy the data written in the disk array apparatus 110 by the channel processor 300 under the control of the write control unit 324 to a predetermined magnetic tape in the tape library apparatus 120, at a predetermined timing after completion of the writing. At this point, the virtual library control unit 211 reads from the data management table 212 the start address of the data, which are to be copied to the magnetic tape, in the disk array apparatus 110, and notifies the device processor 400 of the start address.

Further, for example, when the free space in the disk array apparatus 110 becomes small, the virtual library control unit 211 requests the channel processor 300 to delete from the disk array apparatus 110 the data in the virtual disk with the oldest last access time.

Further, upon reception of a data read request from the host apparatus 500, the virtual library control unit 211 determines whether the requested data are stored in the disk array apparatus 110. If the data requested to be read are stored in the disk array apparatus 110, the virtual library control unit 211 reads the start addresses of respective data blocks of the requested data from the data management table 212, and notifies the reading unit 331 of the channel processor 300 of the start addresses. The reading unit 331 reads data blocks from the disk array apparatus 110 on the basis of the start addresses notified by the virtual library control unit 211, and transmits the data blocks to the host apparatus 500 via the transmitting unit 312.

On the other hand, if the data requested to be read are not stored in the disk array apparatus 110, the virtual library control unit 211 requests the device processor 400 to write a logical volume containing the requested data to the disk array apparatus 110. The device processor 400 writes the requested logical volume to the disk array apparatus 110, and registers the start addresses and block IDs of the respective data blocks of the data in the logical volume into the data management table 212. Then, with the same procedure as in the case where the data requested to be read are registered in the disk array apparatus 110, the virtual library control unit 211 controls the channel processor 300 to transmit the requested data from the disk array apparatus 110 to the host apparatus 500.

Next, a description will be given of the processing functions of the channel processor 300.

When a data write request is issued from the virtual library control processor 200 to the write control unit 324, the receiving unit 311 receives data blocks of the data requested to be written from the host apparatus 500. The receiving unit 311 stores the received data blocks in the RAM 302.

When a data read request is issued from the virtual library control processor 200 to the reading unit 331, the transmitting unit 312 transmits data blocks read from the disk array apparatus 110 by the reading unit 331 or data blocks expanded by the expansion unit 332 to the host apparatus 500.

The compression unit 321 and the writing unit 322 are processing blocks that perform a compressed writing process illustrated in FIG. 6, under the control of the write control unit 324. The compression unit 321 compresses a data block that is received from the host apparatus 500 and stored in the RAM 302 by the receiving unit 311, and generates compressed data. The compression unit 321 stores the generated compressed data in the RAM 302. The writing unit 322 writes to the disk array apparatus 110 the compressed data that are generated by the compression unit 321 and are stored in the RAM 302.

The writing unit 323 is a processing block that performs an uncompressed writing process illustrated in FIG. 6, under the control of the write control unit 324. The writing unit 323 writes to the disk array apparatus 110 a data block received from the host apparatus 500 by the receiving unit 311, without making any changes thereto. Note that compressed data from the writing unit 322 and a data block from the writing unit 323 are written to different regions in the disk array apparatus 110.

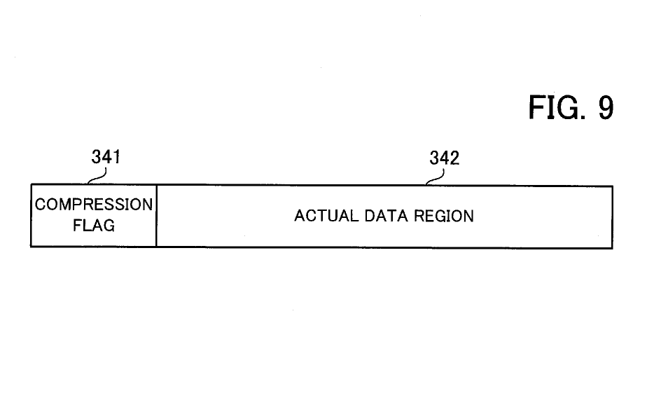

FIG. 9 illustrates an exemplary configuration of data written in the disk array apparatus 110.

The writing units 322 and 323 convert compressed data and a data block, respectively, into a data format including a compression flag 341 and an actual data region 342, for example, as illustrated in FIG. 9, and write the converted data to the disk array apparatus 110. The compression flag 341 indicates whether the data stored in the actual data region 342 are compressed data obtained by compressing a data block or an uncompressed data block. For example, the writing unit 322 sets the compression flag 341 to “1” and stores compressed data generated by the compression unit 321 in the actual data region 342. On the other hand, the writing unit 323 sets the compression flag 341 to “0” and stores an uncompressed data block in the actual data region 342.

Referring back to FIG. 7, upon reception of a read request and a notification of a start address from the virtual library control unit 211 of the virtual library control processor 200, the reading unit 331 reads data corresponding to a data block from the notified start address in the disk array apparatus 110.

The reading unit 331 refers to a compression flag 341 of the data read from the disk array apparatus 110. If the compression flag 341 is “0”, the reading unit 331 outputs the uncompressed data block stored in the actual data region 342 to the transmitting unit 312 so as to transmit the uncompressed data block to the host apparatus 500. On the other hand, if the compression flag 341 is “1”, the reading unit 331 outputs the compressed data stored in the actual data region 342 to the expansion unit 332.

The expansion unit 332 expands the compressed data received from the reading unit 331, and outputs a data block restored by the expansion to the transmitting unit 312 so as to transmit the restored data block to the host apparatus 500.

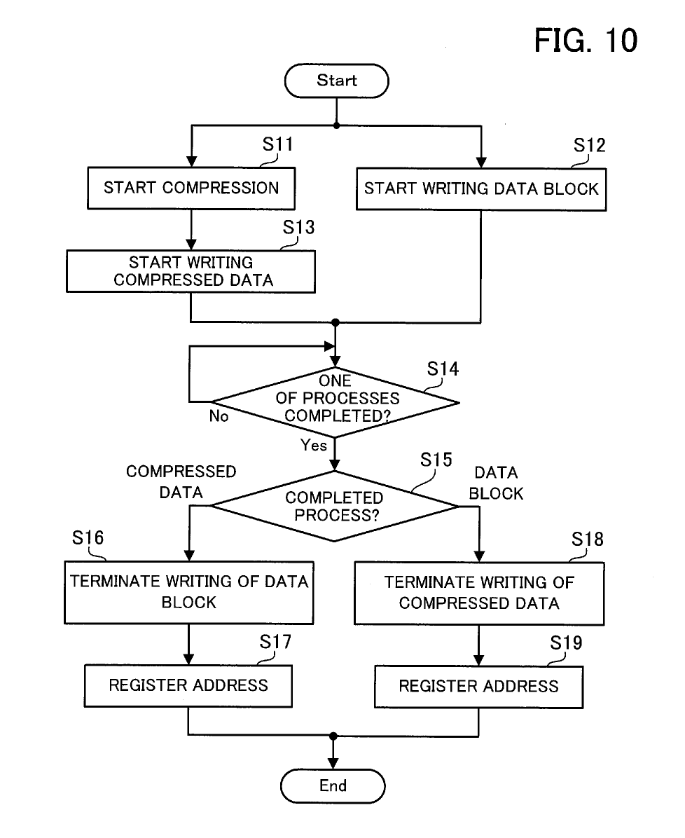

FIG. 10 is a flowchart illustrating an exemplary procedure of writing data to the disk array apparatus 110 by the channel processor 300. This process of FIG. 10 is performed for each data block that is received from the host apparatus 500 and stored in the RAM 302 by the receiving unit 311.

(Step S11) The write, control unit 324 causes the compression unit 321 to start compression of a data block stored in the RAM 302. Thus, the above-described compressed writing process is started.

(Step S12) The write control unit 324 causes the writing unit 323 to start writing the same data block in the RAM 302 as that processed in step S11 to the disk array apparatus 110. The data block is written to an arbitrary location in a physical storage area in the HDDs of the disk array apparatus 110 that is allocated to the logical volume requested by the host apparatus 500 to be written. By performing this step S12, the above-described uncompressed writing process is started.

With the above-described steps S11 and S12, the writing of the data block to the disk array apparatus 110 by the writing unit 323 and the compression of the data block by the compression unit 321 are performed in parallel.

(Step S13) When the compression unit 321 completes the compression of the data block, the writing unit 322 starts writing the compressed data generated by the compression unit 321 to the disk array apparatus 110. The compressed data are written to an arbitrary location (different from the location into which the data block is written in step S12) in a physical storage area in the HDDs of the disk array apparatus 110 that is allocated to the logical volume requested by the host apparatus 500 to be written. By performing this step S13, the writing of the compressed data to the disk array apparatus 110 by the writing unit 322 and the writing of the data block to the disk array apparatus 110 by the writing unit 323 are performed in parallel.

(Step S14) The write control unit 324 monitors whether a write completion notification is received from one of the writing units 322 and 323. When the write control unit 324 receives a write completion notification from one of the writing units 322 and 323 (S14: Yes), the process proceeds to step S15.

(Step S15) If the write control unit 324 receives a write completion notification from the writing unit 322 first in step S14, the process proceeds to step S16. On the other hand, if the write control unit 324 receives a write completion notification from the writing unit 323 first in step S14, the process proceeds to step S18.

(Step S16) The write control unit 324 causes the writing unit 323 to terminate the writing of the data block.

(Step S17) The write control unit 324 obtains, from the writing unit 322, a start address of the data written in the disk array apparatus 110 by the writing unit 322. The write control unit 324 registers the obtained start address and the block ID of the data block for which the writing process is completed into the data management table 212 in the virtual library control processor 200. With this registration operation, the data written in the disk array apparatus 110 by the writing unit 322 are validated.

(Step S18) The write control unit 324 causes the writing unit 322 to terminate the writing of the compressed data.

(Step S19) The write control unit 324 obtains, from the writing unit 323, a start address of the data written in the disk array apparatus 110 by the writing unit 323. The write control unit 324 registers the obtained start address and the block ID of the data block for which the writing process is completed into the data management table 212 in the virtual library control processor 200. With this registration operation, the data written in the disk array apparatus 110 by the writing unit 323 are validated.

As described above, in the process illustrated in FIG. 10, the compressed writing process (S11 and S13) and the uncompressed writing process (S12) are executed in parallel, and the data written in the disk array apparatus 110 by one of these processes that is completed first become valid write data (S17 or S19). Thus, it is possible to reliably reduce the overall processing time taken to write data to the disk array apparatus 110, to save the storage space in the disk array apparatus 110 and the tape library apparatus 120 as much as possible, and to increase the data writing efficiency.

### (c) Third Embodiment

In the above-described second embodiment, the compressed writing process by the compression unit 321 and the writing unit 322 and the uncompressed writing process by the writing unit 323 are executed in parallel until one of the processes is completed. On the other hand, in the third embodiment described below, when a compression unit 321 completes compression, a determination is made as to which of the compressed writing process and the uncompressed writing process takes less processing time.

The configuration of a storage system according to the third embodiment is the same as that of FIG. 2. Further, although the functional configurations of a channel processor 300 and a virtual library control processor 200 used in the third embodiment are the same as those of FIG. 7, control operations by a write control unit 324 are different. Hereinafter, a description will be given of operations by the channel processor 300 in the third embodiment, using the same reference numerals as in FIG. 7.

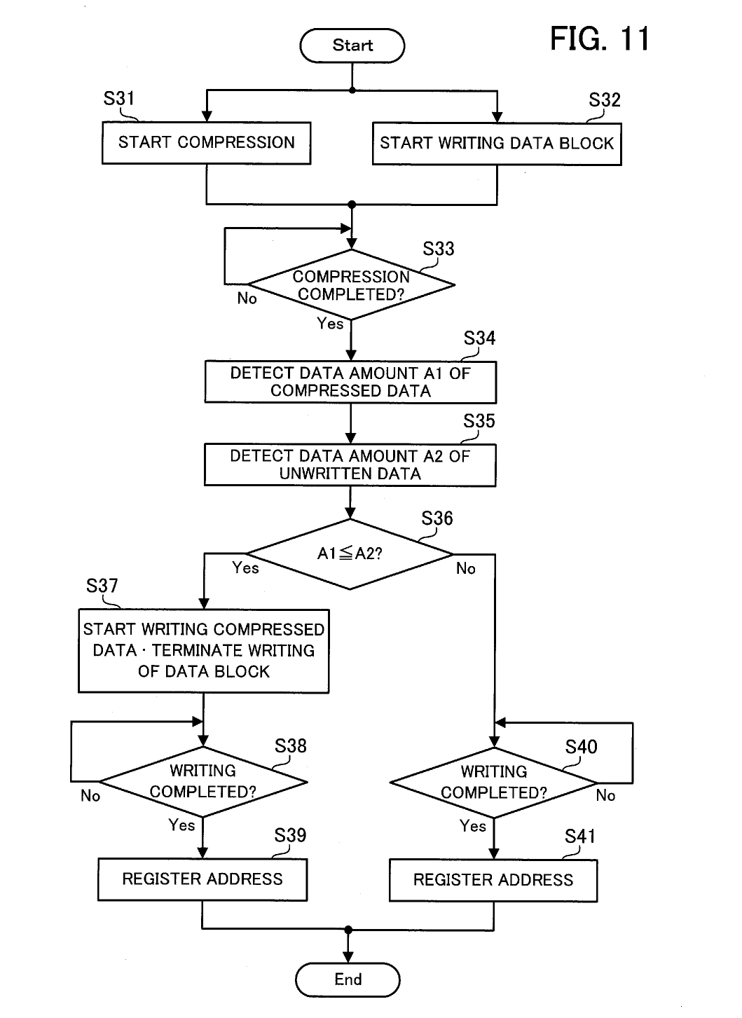

FIG. 11 is a flowchart illustrating an exemplary procedure of writing data to a disk array apparatus 110 by the channel processor 300 according to the third embodiment. This process of FIG. 11 is performed for each data block that is received from a host apparatus 500 and stored in a RAM 302 by a receiving unit 311.

(Step S31) The write control unit 324 causes the compression unit 321 to start compression of a data block stored in the RAM 302. Thus, the above-described compressed writing process is started.

(Step S32) The write control unit 324 causes a writing unit 323 to start writing the same data block in the RAM 302 as that processed in step S31 to the disk array apparatus 110. Thus, the above-described compressed writing process is started.

With the above-described steps S31 and S32, the writing of the data block to the disk array apparatus 110 by the writing unit 323 and the compression of the data block by the compression unit 321 are executed in parallel.

(Step S33) The write control unit 324 monitors whether a compression completion notification is received from the compression unit 321. When the compression unit 321 completes the compression of the data block and the write control unit 324 receives a compression completion notification from the compression unit 321 (S33: Yes), the process proceeds to step S34.

(Step S34) The write control unit 324 detects a data amount A1 of compressed data generated by the compression unit 321. In this operation, the write control unit 324 obtains the data amount A1 from the compression unit 321, for example.

(Step S35) The write control unit 324 detects a data amount A2 of unwritten data in the data block that is started to be written by the writing unit 323 in step S32. In this operation, the write control unit 324 obtains a data amount A3 of data that are already written in the disk array apparatus 110, from the writing unit 323, for example. Then, the write control unit 324 calculates the data amount A2 by subtracting the data amount A3 from the fixed data block length (for example, 256 KB).

Note that steps S34 and S35 may be performed in a reverse order.

(Step S36) The write control unit 324 compares the data amount A1 of the compressed data detected in step S34 with the data amount A2 of the unwritten data detected in step S35. If the write control unit 324 determines that the data amount A1 is less than or equal to the data amount A2 (S36: Yes), the process proceeds to step S37. On the other hand, if the write control unit 324 determines that the data amount A1 is greater than the data amount A2 (S36: No), the process proceeds to step S40.

Note that in the above-described steps S34 and S35, the writing unit 323 may detect, for example, a residual rate R1 of the compressed data and a writing non-completion rate R2 indicating the percentage of the unwritten data with respect to the whole data block, in place of the data amounts A1 and A2, respectively. In this case, in step S36, if the write control unit 324 determines that the residual rate R1 is less than or equal to the writing non-completion rate R2, the process proceeds to step S37. On the other hand, if the write control unit 324 determines that the residual rate R1 is greater than the writing non-completion rate R2, the process proceeds to step S40.

(Step S37) The write control unit 324 causes the writing unit 322 to start writing the compressed data generated in step S33 to the disk array apparatus 110. In the meantime, the write control unit 324 causes the writing unit 323 to terminate the writing of the data block.

(Step S38) The write control unit 324 monitors whether a write completion notification is received from the writing unit 322. When the write control unit 324 receives a write completion notification from the writing unit 322 (S38: Yes), the process proceeds to step S39.

(Step S39) The write control unit 324 obtains, from the writing unit 322, a start address of the data written in the disk array apparatus 110 by the writing unit 322. The write control unit 324 registers the obtained start address and the block ID of the data block for which the writing process is completed into the data management table 212 in the virtual library control processor 200. With this registration operation, the data written in the disk array apparatus 110 by the writing unit 322 are validated.

(Step S40) The write control unit 324 monitors whether a write completion notification is received from the writing unit 323. When the write control unit 324 receives a write completion notification from the writing unit 323 (S40: Yes), the process proceeds to step S41.

(Step S41) The write control unit 324 obtains, from the writing unit 323, a start address of the data written in the disk array apparatus 110 by the writing unit 323. The write control unit 324 registers the obtained start address and the block ID of the data block for which the writing process is completed into the data management table 212 in the virtual library control processor 200. With this registration operation, the data written in the disk array apparatus 110 by the writing unit 323 are validated.

As described above, in the process illustrated in FIG. 11, the write control unit 324 performs the data compression (S31) of the compressed writing process and the uncompressed writing process (S32) in parallel. Then, upon completion of the data compression (S33), the write control unit 324 determines which of the compressed writing process and the uncompressed writing process takes less processing time on the basis of the data amounts A1 and A2 (S34 through S36). If the compressed writing process is determined to take less processing time or if these processes are determined to take the same time (S36: Yes), the write control unit 324 continues the compressed writing process, and terminates the uncompressed writing process (S37). On the other hand, if the uncompressed writing process is determined to take less processing time (S36: No), the write control unit 324 continues the uncompressed writing process, and terminates the compressed writing process by preventing the writing unit 322 to write the compressed data.

With this process, as in the case of the second embodiment, it is possible to reliably reduce the overall processing time taken to write data to the disk array apparatus 110, to save the storage space in the disk array apparatus 110 and the tape library apparatus 120 as much as possible, and to increase the data writing efficiency. Further, after completion of compression of the data block, only one of the writing units 322 and 323 performs writing. Therefore, it is possible to reduce the processing load of the CPU 301 of the channel processor 300 compared with that of the second embodiment.

In the case where the processing time that the compression unit 321 takes to perform compression is constant for all the data blocks, the data amount A2 detected in step S35 of FIG. 11 is constant. That is, in place of performing the operations of steps S35 and S36, the write control unit 324 may compare the data amount A1 (or the residual rate R1) detected in step S34 with a predetermined threshold. In this case, if the write control unit 324 determines that the data amount A1 (or the residual rate R1) is less than or equal to the threshold, the process proceeds to step S37. On the other hand, if the write control unit 324 determines that the data amount A1 (or the residual rate R1) is greater than the threshold, the process proceeds to step S40.

### (d) Fourth Embodiment

In the above-described second and third embodiments, since there is a period during which a compressed writing process and an uncompressed writing process are executed in parallel, the processing load of the CPU 301 of the channel processor 300 might become high. That is, parallel execution of a compressed writing process and an uncompressed writing process reduces the processing performance of the channel processor 300, which might increase the time taken for a writing process for each data block. In view of this, in a fourth embodiment described below, when the processing load of a CPU 301 is high, only one of a compressed writing process and an uncompressed writing process is executed so as to prevent the processing load of the CPU 301 from becoming excessively high.

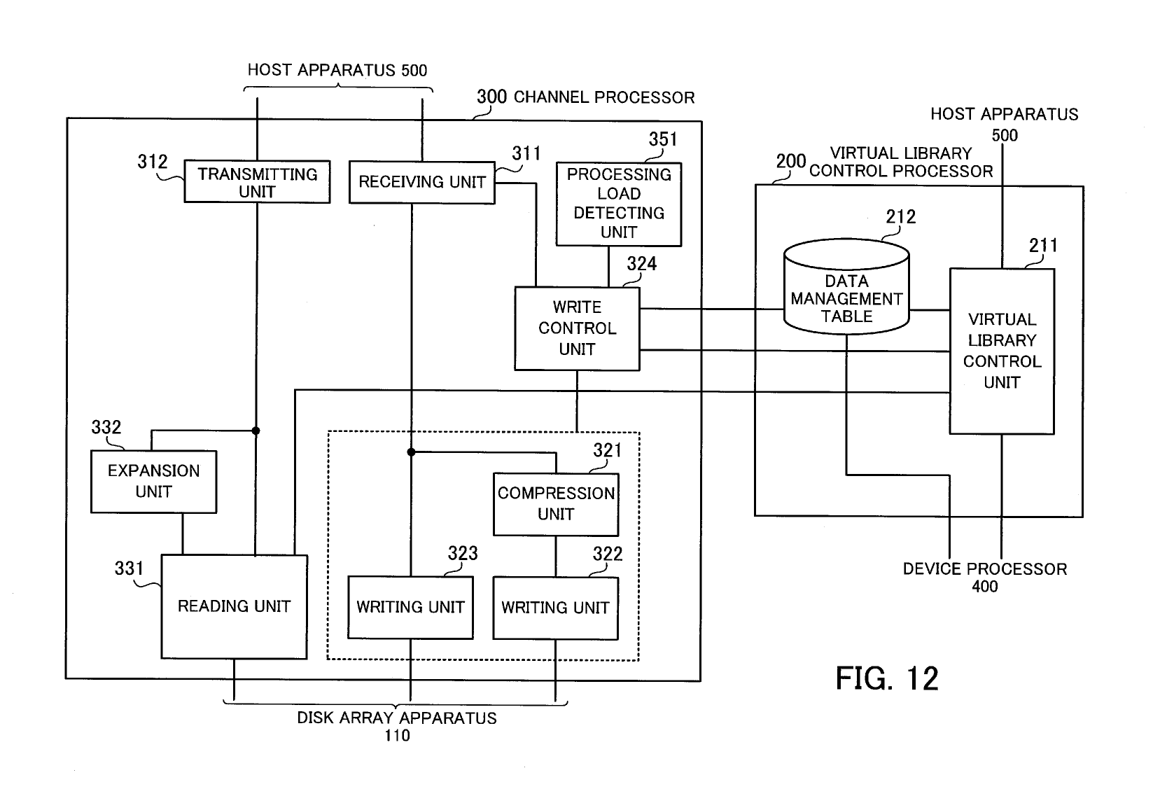

FIG. 12 is a functional block diagram illustrating a channel processor 300 and a virtual library control processor 200 according to the fourth embodiment. In FIG. 12, the processing blocks corresponding to those in FIG. 7 are denoted by the same reference numerals.

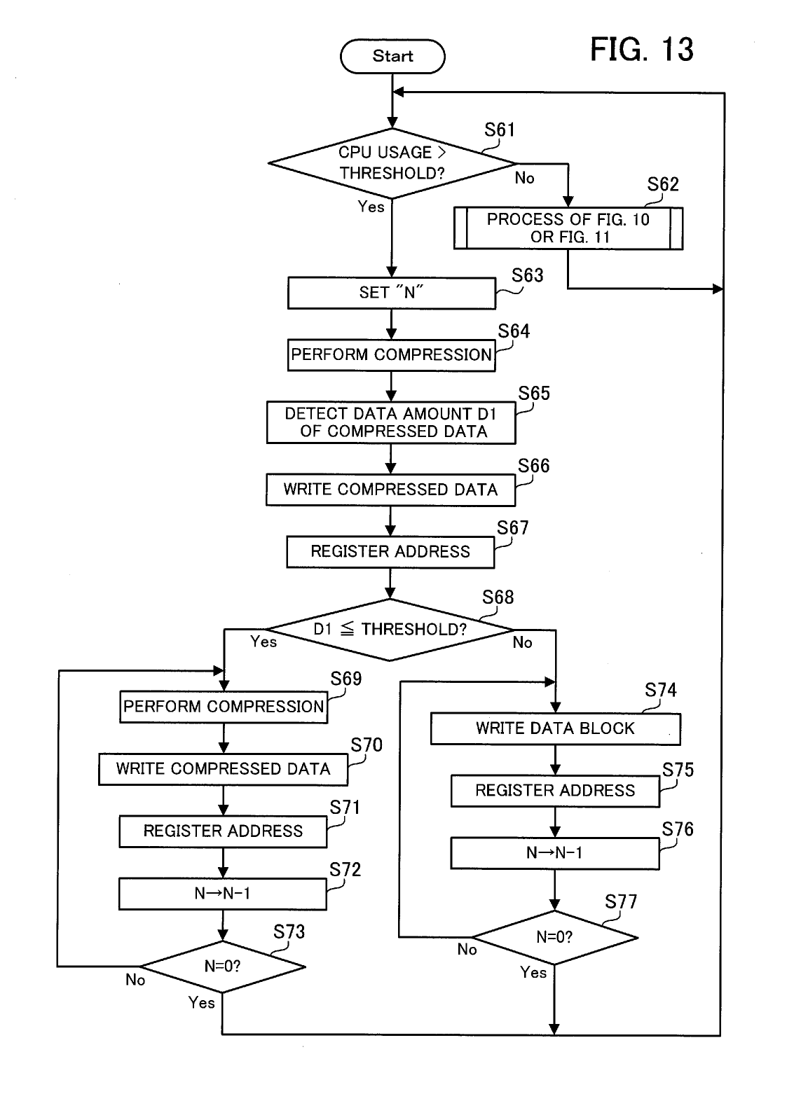

The channel processor 300 of the fourth embodiment further includes a processing load detecting unit 351 in addition to the components of the second and third embodiments. The processing load detecting unit 351 detects the usage of the CPU 301 of the channel processor 300. Further, in the channel processor 300 of the fourth embodiment, as illustrated in FIG. 13, if the usage of the CPU 301 exceeds a threshold, a write control unit 324 controls such that only one of the compressed writing process and uncompressed writing process is executed.

FIG. 13 is a flowchart illustrating an exemplary procedure of writing data to a disk array apparatus 110 by the channel processor 300 according to the fourth embodiment.

(Step S61) The write control unit 324 obtains a usage of the CPU 301 from the processing load detecting unit 351. If the write control unit 324 determines that the usage of the CPU 301 is higher than a predetermined threshold (S61: Yes), the process proceeds to step S63. On the other hand, if the write control unit 324 determines that the usage of the CPU 301 is lower than or equal to the predetermined threshold (S61: No), the process proceeds to step S62.

(Step S62) The write control unit 324 performs the process illustrated in FIG. 10 or FIG. 11, and thereby causes a compression unit 321 and writing units 322 and 323 to write, to the disk array apparatus 110, the data block received from a host apparatus 500 and stored in a RAM 302 by a receiving unit 311.

Subsequently, if the write control unit 324 determines that there is a data block that is not written in the disk array apparatus 110, among the data blocks of the write data requested by the host apparatus 500 to be written, the process returns to step S61. Although not illustrated, if the write control unit 324 determines that all the data blocks of the write data are already written in the disk array apparatus 110, the process ends.

(Step S63) The write control unit 324 sets a variable N to a predetermined value. For example, the write control unit 324 reads the predetermined value from the HDD 303. The value to which the variable N is set in this operation indicates the number of times that only one of the compressed writing process and the uncompressed writing process is successively performed. The variable N is an integer equal to or greater than 1.

(Step S64) The write control unit 324 causes the compression unit 321 to compress the data block.

(Step S65) When the compression unit 321 completes the compression and the obtained compressed data are stored in the RAM 302, the write control unit 324 detects a data amount D1 of the obtained compressed data. In this operation, the write control unit 324 obtains the data amount D1 from the compression unit 321, for example.

(Step S66) The write control unit 324 causes the writing unit 322 to write the compressed data to the disk array apparatus 110.

With these operations of steps S64 and S66, a compressed writing process is performed.

(Step S67) When the writing unit 322 completes the writing of the compressed data, the write control unit 324 obtains, from the writing unit 322, a start address of the data written in the disk array apparatus 110 by the writing unit 322. The write control unit 324 registers the obtained start address and the block ID of the data block for which the writing process is completed into the data management table 212 in the virtual library control processor 200. With this registration operation, the data written in the disk array apparatus 110 by the writing unit 322 are validated.

(Step S68) If there is a data block that is not written in the disk array apparatus 110, among the data blocks of the write data requested by the host apparatus 500 to be written, the write control unit 324 compares the data amount D1 of the compressed data detected in step S65 with the predetermined threshold. If the write control unit 324 determines that the data amount D1 is less than or equal to a threshold (S68: Yes), the process proceeds to step S69. On the other hand, if the write control unit 324 determines that the data amount D1 is greater than the threshold (S68: No), the process proceeds to step S74.

Although not illustrated, if the write control unit 324 determines that all the data blocks of the write data are already written in the disk array apparatus 110, the process ends.

In the above step S65, for example, the residual rate R1 may be detected in place of the data amount D1 of the compressed data. In this case, in step S68, if the write control unit 324 determines that the residual rate R1 is less than or equal to a threshold, the process proceeds to step S69. On the other hand, if the write control unit 324 determines that the residual rate R1 is greater than the threshold, the process proceeds to step S74.

Further, the detection of the data amount D1 (or the residual rate R1) in step S65 may be performed at any time after completion of the compression but before the start of the operation of step S68.

(Step S69) The write control unit 324 causes the compression unit 321 to compress a subsequent data block.

(Step S70) When the compression unit 321 completes the compression and the obtained compressed data are stored in the RAM 302, the write control unit 324 causes the writing unit 322 to write the compressed data to the disk array apparatus 110.

With these operations of steps S69 and S70, a compressed writing process is performed.

(Step S71) When the writing unit 322 completes the writing of the compressed data, the write control unit 324 obtains, from the writing unit 322, a start address of the data written in the disk array apparatus 110 by the writing unit 322. The write control unit 324 registers the obtained start address and the block ID of the data block for which the writing process is completed into the data management table 212 in the virtual library control processor 200. With this registration operation, the data written in the disk array apparatus 110 by the writing unit 322 are validated.

(Step S72) The write control unit 324 decrements the variable N by “1”.

Note that steps S71 and S72 may be performed in a reverse order.

(Step S73) If there is a data block that is not written in the disk array apparatus 110, among the data blocks of the write data requested by the host apparatus 500 to be written, the write control unit 324 determines whether the variable N is “0”. If the write control unit 324 determines that the variable is equal to or greater than “1” (S73: No), the process returns to step S69, in which the write control unit 324 causes the compression unit 321 and the writing unit 322 to execute a compressed writing process of a subsequent data block. On the other hand, if the write control unit 324 determines that the variable is “0” (S73: Yes), the process returns to step S61.

(Step S74) The write control unit 324 causes the writing unit 323 to execute an uncompressed writing process for writing a subsequent data block to the disk array apparatus 110.

(Step S75) When the writing unit 323 completes the writing of the data block, the write control unit 324 obtains, from the writing unit 323, a start address of the data written in the disk array apparatus 110 by the writing unit 323. The write control unit 324 registers the obtained start address and the block ID of the data block for which the writing process is completed into the data management table 212 in the virtual library control processor 200. With this registration operation, the data written in the disk array apparatus 110 by the writing unit 323 are validated.

(Step S76) The write control unit 324 decrements the variable N by 1.

Note that steps S75 and S76 may be performed in a reverse order.

(Step S77) If there is a data block that is not written in the disk array apparatus 110, among the data blocks of the write data requested by the host apparatus 500 to be written, the write control unit 324 determines whether the variable N is “0”. If the write control unit 324 determines that the variable N is equal to or greater than “1” (S77: No), the process returns to step S74 in which the write control unit 324 causes the writing unit 323 to execute an uncompressed writing process of a subsequent data block. On the other hand, if the write control unit 324 determines that the variable is “0” (S77: Yes), the process returns to step S61.

In the above-described process of FIG. 13, if the usage of the CPU 301 is less than or equal to the predetermined value in step S61, parallel execution of a compressed writing process and an uncompressed writing process is started. Then, the data written in the disk array apparatus 110 by one of these processes that takes less processing time are validated (S62).

On the other hand, if the usage of the CPU 301 is greater than the predetermined value in step S61, a compressed writing process of a data block is executed first (S64 and S66). Further, in accordance with the data amount (or the residual rate) of the compressed data obtained by the compressed writing process, only one of the compressed writing process (S69 and S70) and the uncompressed writing process (S74) is performed for the subsequent N consecutive data blocks. This reduces the processing load of the CPU 301 of the channel processor 300, and thus prevents a reduction in performance of the channel processor 300. Accordingly, it is possible to prevent the time taken for a writing process for each data block from becoming longer than the time taken to write an uncompressed data block to the disk array apparatus 110 in a normal state (low processing load state).

Further, in accordance with the data amount (or the residual rate) of the compressed data obtained by the compressed writing process in step S64, a determination is made as to which of the compressed writing process and the uncompressed writing process is performed for the subsequent N consecutive data blocks. Since the consecutive data blocks are highly likely to have close residual rates after compression, it is possible to reduce the time taken to write data to the disk array apparatus 110.

Note that, in the second through fourth embodiments described above, the virtual library control processor 200 stores the data management table 212. However, for example, the channel processor 300 or the disk array apparatus 110 may store the data management table 212.

Further, in place of the channel processor 300, the disk array apparatus 110 may have the processing functions (i.e., the compression unit 321, the writing units 322 and 323, and the write control unit 324) for compressing data to be written to the disk array apparatus 110, for example. In this case, for instance, the above-described processing functions may be realized by a control circuit that performs overall control of the plurality of HDDs in the disk array apparatus 110, or may be realized by a control circuit (interface circuit) of each HDD in the disk array apparatus 110.

Further, in each of the storage systems in the above-described second through fourth embodiments, data to be written to the disk array apparatus 110 are compressed. However, data compression may be performed upon writing data stored in the disk array apparatus 110 to a magnetic tape in the tape library apparatus 120. In this case, for example, any one of the disk array apparatus 110, the device processor 400, and the tape library apparatus 120 may have the above-described processing functions of the compression unit 321, the writing units 322 and 323, and the write control unit 324.

Further, the processing functions of the information processing apparatus and the channel processor in the above-described embodiments may be realized by a computer. In this case, a program describing the functions of each apparatus is provided. When the program is executed by a computer, the above-described processing functions are implemented on the computer. The program describing the functions may be stored in a computer-readable recording medium. Examples of computer-readable recording media include magnetic storage devices, optical discs, magneto-optical storage media, semiconductor memory devices, and the like. Examples of magnetic storage devices include HDD, flexible disk (FD), magnetic tapes, and the like. Examples of optical discs include DVD, DVD-RAM, CD-ROM, CD-RW, and the like. Examples of magneto-optical storage media include magneto-optical disk (MO) and the like.

For distributing the program, the program may be stored and sold in the form of a portable storage medium such as DVD, CD-ROM, and the like, for example. Further, the program may be stored in a storage device of a server computer so as to be transmitted from the server computer to other computers over a network.

For executing the program on a computer, the computer stores the program recorded on the portable storage medium or the program transmitted from the server computer in its storage device. Then, the computer reads the program from its storage device, and executes processing in accordance with the program. Note that the computer may read the program directly from the portable storage medium so as to execute processing in accordance with the program. Alternatively, the computer may sequentially receive the program from a server computer connected over a network, and perform processing in accordance with the received program.

According to the above-described information processing apparatus and write control method, it is possible to reduce the amount of data stored in the storage device, and also to reduce the time taken to store the data.

Further, according to the above-described storage system, it is possible to reduce the amount of data stored in each of the first and second storage apparatuses, and also to reduce the time taken to store the data in the first storage apparatus.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus comprising:
a processor configured to perform a procedure including:
executing a first process of writing, to a storage apparatus, first data that are requested to be written to the storage apparatus, and a second process of compressing the first data and writing second data that are obtained by the compression to the storage apparatus; and
terminating one of the first and second processes that takes longer processing time.

2. The information processing apparatus according to claim 1, wherein:
when the second data are obtained by the compression in the second process, the processor compares an amount of the obtained second data with an amount of unwritten data of the first data which are yet to be written in the first process; and
when the amount of the second data is greater than the amount of the unwritten data, the processor continues the first process and terminates the second process, and when the amount of the second data is less than or equal to the amount of the unwritten data, the processor continues the second process and terminates the first process.

3. The information processing apparatus according to claim 1, wherein upon detection of completion of one of the first and second processes, the processor terminates the other one of the first and second processes that is not completed.

4. The information processing apparatus according to claim 1, wherein:
upon reception of a request for writing the first data, the processor detects a processing load of the information processing apparatus; and
when a value indicating the detected processing load is greater than a predetermined value, the processor executes the second process without executing the first process.

5. The information processing apparatus according to claim 4, wherein:
when the value indicating the processing load is greater than the predetermined value and the second process is executed, the processor detects an amount of the second data that are obtained by the compression; and
when the amount of the second data is less than or equal to a predetermined determination threshold, the processor executes the second process for subsequent data that are requested to be written to the storage apparatus, without executing the first process, and when the amount of the second data is greater than the predetermined determination threshold, the processor executes the first process for the subsequent data that are requested to be written to the storage apparatus, without executing the second process.

6. A storage system comprising:
a first storage apparatus;
a second storage apparatus;
a storage control apparatus configured to control a hierarchical storage system in which the first storage apparatus serves as a primary storage and the second storage apparatus serves as a secondary storage; and
an access apparatus configured to access the first storage apparatus when access to data in the hierarchical storage system is requested by an upper apparatus, wherein:
the access apparatus executes a first process of writing, to the first storage apparatus, first data that are requested by the upper apparatus to be written to the hierarchical storage system, and a second process of compressing the first data and writing second data that are obtained by the compression to the first storage apparatus; and
the access apparatus terminates one of the first and second processes that takes longer processing time.

7. The storage system according to claim 6, wherein:
when the second data are obtained by the compression in the second process, the access apparatus compares an amount of the obtained second data with an amount of unwritten data of the first data which are yet to be written in the first process; and
when the amount of the second data is greater than the amount of the unwritten data, the access apparatus continues the first process and terminates the second process, and when the amount of the second data is less than or equal to the amount of the unwritten data, the access apparatus continues the second process and terminates the first process.

8. The storage system according to claim 6, wherein upon detection of completion of one of the first and second processes, the access apparatus terminates the other one of the first and second processes that is not completed.

9. The storage system according to claim 6, wherein:
upon reception of a request for writing the first data, the access apparatus detects a processing load of the access apparatus; and
when a value indicating the detected processing load is greater than a predetermined value, the access apparatus executes the second process without executing the first process.

10. The storage system according to claim 9, wherein:
when the value indicating the processing load is greater than the predetermined value and the second process is executed, the access apparatus detects an amount of the second data that are obtained by the compression; and
when the amount of the second data is less than or equal to a predetermined determination threshold, the access apparatus executes the second process for subsequent data that are requested to be written to the hierarchical storage system, without executing the first process, and when the amount of the second data is greater than the predetermined determination threshold, the access apparatus executes the first process for the subsequent data that are requested to be written to the hierarchical storage system, without executing the second process.

11. A write control method comprising:
executing, by an information processing apparatus, a first process of writing, to a storage apparatus, first data that are requested to be written to the storage apparatus, and a second process of compressing the first data and writing second data that are obtained by the compression to the storage apparatus; and
terminating, by the information processing apparatus, one of the first and second processes that takes longer processing time.

12. The write control method according to claim 11, wherein:
when the second data are obtained by the compression in the second process, the information processing apparatus compares an amount of the obtained second data with an amount of unwritten data of the first data which are yet to be written in the first process; and
when the amount of the second data is greater than the amount of the unwritten data, the information processing apparatus continues the first process and terminates the second process, and when the amount of the second data is less than or equal to the amount of the unwritten data, the information processing apparatus continues the second process and terminates the first process.

13. The write control method according to claim 11, wherein upon detection of completion of one of the first and second processes, the information processing apparatus terminates the other one of the first and second processes that is not completed.

14. The write control method according to claim 11, wherein:
upon reception of a request for writing the first data, the information processing apparatus detects a processing load of the information processing apparatus; and
when a value indicating the detected processing load is greater than a predetermined value, the information processing apparatus executes the second process without executing the first process.

15. The write control method according to claim 14, wherein:
when the value indicating the processing load is greater than the predetermined value and the second process is executed, the information processing apparatus detects an amount of the second data that are obtained by the compression; and
when the amount of the second data is less than or equal to a predetermined determination threshold, the information processing apparatus executes the second process for subsequent data that are requested to be written to the storage apparatus, without executing the first process, and when the amount of the second data is greater than the predetermined determination threshold, the information processing apparatus executes the first process for the subsequent data that are requested to be written to the storage apparatus, without executing the second process.
